(19) United States
(12) Patent Application Publication
(10) Pub. No.: US 2019/0094069 A1
(43) Pub. Date: Mar. 28, 2019

(54) Electronic Devices Having Infrared Blocking Light Guides

(71) Applicant: Apple Inc., Cupertino, CA (US)

(72) Inventors: Tingjun Xu, San Jose, CA (US); Avery P. Yuen, San Jose, CA (US); James W. Hillendahl, Vacaville, CA (US); Ligang Wang, San Jose, CA (US); Ove Lyngnes, Carmel Valley, CA (US); Sunggu Kang, San Jose, CA (US); Xianwei Zhao, Fremont, CA (US); Xingxing Cai, Santa Clara, CA (US)

(21) Appl. No.: 16/038,916

(22) Filed: Jul. 18, 2018

Related U.S. Application Data
(60) Provisional application No. 62/564,132, filed on Sep. 27, 2017.

(51) Int. Cl. G01J 1/16; G01J 1/04; G09G 3/34; H05B 37/02; G02B 6/02

(52) U.S. Cl. CPC G01J 1/16; G01J 1/0425; G02B 6/02038; G09G 3/3406; H05B 37/0218; G01J 1/0474

(57) ABSTRACT

An electronic device may be provided with a display. An opaque layer may be formed on an inner surface of a display cover layer in an inactive area of the display. An optical component window may be formed from the opening. A light guide may be aligned with the optical component window and may be used to guide light from the optical component window to an optical component such as an ambient light sensor. The light guide may have a core surrounded by a cladding. The core may be formed from a material such as blue glass that absorbs infrared light and that transmits visible light. Particles of titanium dioxide or other high-refractive-index material may be incorporated into the core to enhance the refractive index of the core. Thin-film interference filters may be formed on the light guide to enhance infrared light blocking.

This application claims the benefit of provisional patent application No. 62/564,132, filed Sep. 27, 2017, which is hereby incorporated by reference herein in its entirety.

### FIELD

This relates generally to electronic devices, and, more particularly, to electronic devices with optical components such as ambient light sensors.

### BACKGROUND

Electronic devices such as laptop computers, cellular telephones, and other equipment are sometimes provided with optical components. For example, an electronic device may have an ambient light sensor for gathering measurements of ambient light levels. Ambient light information may be used in adjusting screen brightness during operation of an electronic device. If ambient light levels brighten, for example, display brightness can be increased to ensure that content is not obscured on a user's display. Color ambient light readings may be used in adjusting the white point of a display.

Ambient light sensors are sensitive to visible light. If an ambient light sensing system is influenced by infrared light, visible light readings may be inaccurate. This can lead to undesired fluctuations in screen brightness or other undesired behaviors.

### SUMMARY

An electronic device may be provided with a display. The display may be overlapped by a display cover layer. An opaque layer may be formed on an inner surface of the display cover layer in an inactive area of the display. An optical component window may be formed from the opening. Optical component windows may also be formed in other portions of an electronic device.

The electronic device may include optical components such as ambient light sensors and other devices that emit light and that detect light. A light guide may be aligned with an optical component window and may be used to guide light between the optical component window and the optical component.

The light guide may have a core surrounded by a cladding. The core may be formed from a material such as blue glass that absorbs infrared light and that transmits visible light. Particles of titanium dioxide or other high-refractive-index material may be incorporated into the blue glass of the core to enhance the refractive index of the core relative to the cladding. Thin-film interference filters may be formed on the light guide to enhance infrared light blocking.

### BRIEF DESCRIPTION OF THE DRAWINGS

FIG. 1 is a schematic diagram of an illustrative electronic device in accordance with an embodiment.

FIG. 2 is a perspective view of an illustrative electronic device with a display having optical component windows overlapping optical components such as an ambient light sensor in accordance with an embodiment.

FIG. 3 is a cross-sectional side view of an illustrative electronic device that has optical components such as a light source, image sensor, and ambient light sensor in accordance with an embodiment.

FIG. 4 is a cross-sectional side view of an illustrative ambient light sensor in accordance with an embodiment.

FIG. 5 is a cross-sectional side view of an illustrative light guide for an ambient light sensor in accordance with an embodiment.

FIG. 6 is a graph in which light transmission has been plotted as a function of wavelength for illustrative light guide and filter structures in accordance with an embodiment.

FIG. 7 is a cross-sectional side view of a portion of an electronic device having a bent light guide in accordance with an embodiment.

FIG. 8 is a cross-sectional side view of an illustrative bent light guide formed from a fiber bundle in accordance with an embodiment.

FIG. 9 is a cross-sectional side view of an illustrative light guide formed from a prism in accordance with an embodiment.

FIG. 10 is a cross-sectional side view of an illustrative light guide with prism structures in accordance with an embodiment.

### DETAILED DESCRIPTION

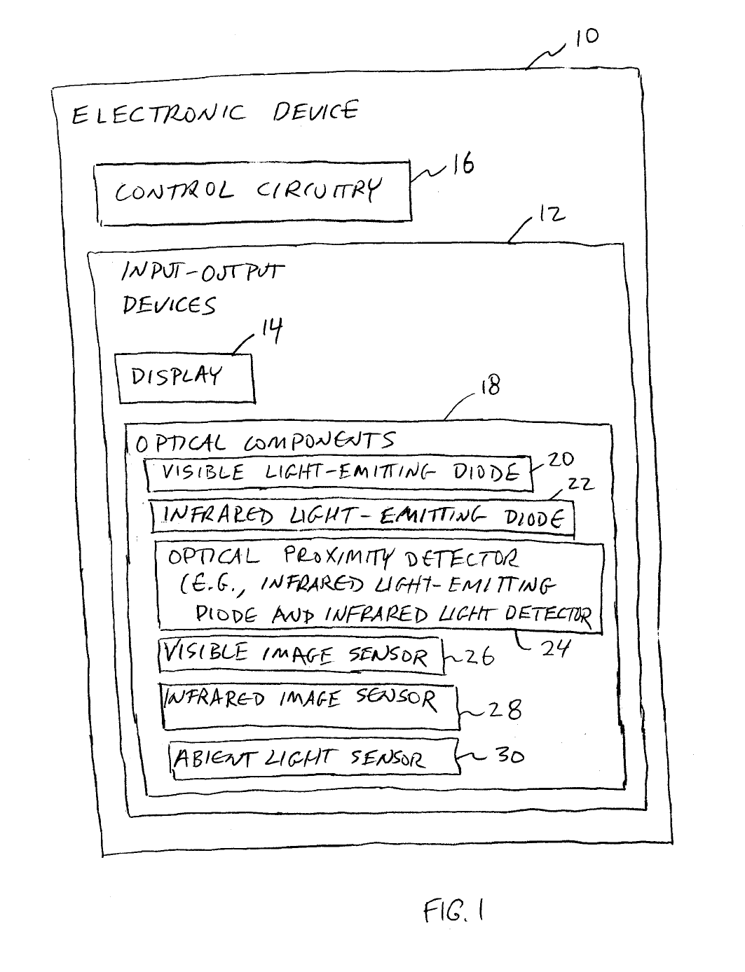

A schematic diagram of an illustrative electronic device of the type that may be provided with an optical component such as an ambient light sensor is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

As shown in FIG. 1, electronic device 10 may have control circuitry 16. Control circuitry 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc.

Device 10 may have input-output circuitry such as input-output devices 12. Input-output devices 12 may include user input devices that gather user input and output components that provide a user with output. Devices 12 may also include communications circuitry that receives data for device 10 and that supplies data from device 10 to external devices. Devices 12 may also include sensors that gather information from the environment.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements. Display 14 may be a liquid crystal display, a light-emitting diode display (e.g., an organic light-emitting diode display), an electrophoretic display, or other display.

Input-output devices 12 may include optical components 18. Optical components 18 may include light-emitting diodes and other light sources. As an example, optical components 18 may include one or more visible light-emitting diodes such as light-emitting diode 20. Light-emitting diode 20 may provide constant illumination (e.g., to implement a flashlight function for device 10) and/or may emit pulses of flash illumination for a visible light camera such as visible light image sensor 26. Optical components 18 may also include an infrared light source (e.g., a laser, lamp, light-emitting diode, etc.) such as infrared light-emitting diode 22. Infrared light-emitting diode 22 may provide constant and/or pulsed illumination at an infrared wavelength such as 940 nm, a wavelength in the range of 800-1100 nm, etc. For example, infrared-light-emitting diode 22 may provide constant illumination for an infrared camera such as infrared image sensor 28. Infrared image sensor 28 may, as an example, be configured to capture iris scan information from the eyes of a user and/or may be used to capture images for a facial recognition process implemented on control circuitry 16.

Optical components 18 may also include optical proximity detector 24 and ambient light sensor 30.

Optical proximity detector 24 may include an infrared light source such as an infrared light-emitting diode and a corresponding light detector such as an infrared photodetector for detecting when an external object that is illuminated by infrared light from the light-emitting diode is in the vicinity of device 10.

Ambient light sensor 30 may be a monochrome ambient light sensor that measures the intensity of ambient light or may be a color ambient light sensor that measures ambient light color and intensity by making light measurements with multiple photodetectors each of which is provided with a corresponding color filter (e.g., color filter that passes red light, blue light, yellow light, green light, or light of other colors) and each of which therefore responds to ambient light in a different wavelength band.

In addition to optical components 18, input-output devices 12 may include buttons, joysticks, scrolling wheels, touch pads, key pads, keyboards, microphones, speakers, tone generators, vibrators, cameras, light-emitting diodes and other status indicators, non-optical sensors (e.g., temperature sensors, microphones, capacitive touch sensors, force sensors, gas sensors, pressure sensors, sensors that monitor device orientation and motion such as inertial measurement units formed from accelerometers, compasses, and/or gyroscopes), data ports, etc. A user can control the operation of device 10 by supplying commands through input-output devices 12 and may receive status information and other output from device 10 using the output resources of input-output devices 12.

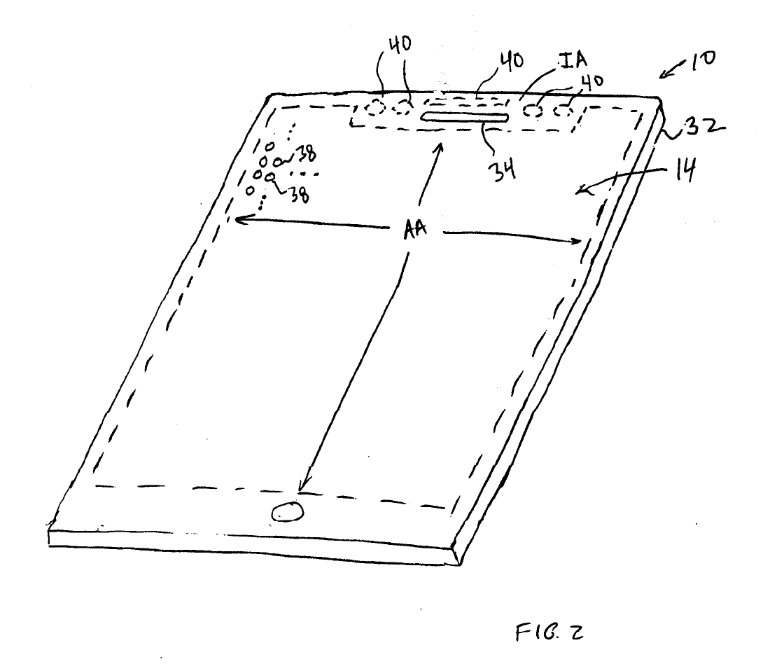

Device 10 may have a housing. The housing may form a laptop computer enclosure, an enclosure for a wristwatch, a cellular telephone enclosure, a tablet computer enclosure, or other suitable device enclosure. A perspective view of a portion of an illustrative electronic device is shown in FIG. 2. In the example of FIG. 2, device 10 includes a display such as display 14 mounted in housing 32. Housing 32, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 32 may be formed using a unibody configuration in which some or all of housing 32 is machined or molded as a single structure or may be formed using multiple structures (e.g., an internal frame structure, one or more structures that form exterior housing surfaces, etc.). Housing 32 may have any suitable shape. In the example of FIG. 2, housing 32 has a rectangular outline (footprint when viewed from above) and has four peripheral edges (e.g., opposing upper and lower edges and opposing left and right edges). Sidewalls may run along the periphery of housing 32.

Display 14 may be protected using a display cover layer such as a layer of transparent glass, clear plastic, sapphire, or other clear layer (e.g., a transparent planar member that forms some or all of a front face of device 10 or that is mounted in other portions of device 10). Openings may be formed in the display cover layer. For example, an opening may be formed in the display cover layer to accommodate a button, a speaker port such as speaker port 34, or other components. Openings may be formed in housing 32 to form communications ports (e.g., an audio jack port, a digital data port, etc.), to form openings for buttons, etc. In some configurations, housing 32 may have a rear housing wall formed from a planar glass member or other transparent layer (e.g., a planar member formed on a rear face of device 10 opposing a front face of device 10 that includes a display cover layer).

Display 14 may have an array of pixels 38 in active area AA (e.g., liquid crystal display pixels, organic light-emitting diode pixels, electrophoretic display pixels, etc.). Pixels 38 of active area AA may display images for a user of device 10. Active area AA may be rectangular, may have notches along one or more of its edges, may be circular, may be oval, may be rectangular with rounded corners, and/or may have other suitable shapes.

Inactive portions of display 14 such as inactive border area IA may be formed along one or more edges of active area AA. Inactive border area IA may overlap circuits, signal lines, and other structures that do not emit light for forming images. To hide inactive circuitry and other components in border area IA from view by a user of device 10, the underside of the outermost layer of display 14 (e.g., the display cover layer or other display layer) may be coated with an opaque masking material such as a layer of black ink (e.g., polymer containing black dye and/or black pigment, opaque materials of other colors, etc.) and/or other layers (e.g., metal, dielectric, semiconductor, etc.). Opaque masking materials such as these may also be formed on an inner surface of a planar rear housing wall formed from glass, ceramic, polymer, crystalline transparent materials such as sapphire, or other transparent material.

In the example of FIG. 2, speaker port 34 is formed from an elongated opening (e.g., a strip-shaped opening) that extends along a dimension parallel to the upper peripheral edge of housing 32. A speaker may be mounted within device housing 32 in alignment with the opening for speaker port 34. During operation of device 10, speaker port 34 serves as an ear speaker port for a user of device 10 (e.g., a user may place opening 34 adjacent to the user's ear during telephone calls).

Optical components 18 (e.g., a visible digital image sensor, an infrared digital image sensor, a light-based proximity sensor, an ambient light sensor, visible and/or infrared light-emitting diodes that provide constant and/or pulsed illumination, etc.) may be mounted under one or more optical component windows such as optical component windows 40. In the example of FIG. 2, four of windows 40 have circular outlines (e.g., circular footprints when viewed from above) and one of windows 40 has an elongated strip-shaped opening (e.g., an elongated strip-shaped footprint when viewed from above). The elongated window 40 is mounted between the sidewall along the upper peripheral edge of device 10 and speaker port 34 and extends parallel to the upper peripheral edge of housing 32. If desired, windows such as optical windows 40 may have shapes other than circular and rectangular shapes. The examples of FIG. 2 are merely illustrative.

Optical component windows such as windows 40 may be formed in inactive area IA of display 14 (e.g., an inactive border area in a display cover layer such as an inactive display region extending along the upper peripheral edge of housing 32) or may be formed in other portions of device 10 such as portions of a rear housing wall formed from a transparent member coated with opaque masking material, portions of a metal housing wall, polymer wall structures, etc. In the example of FIG. 2, windows 40 are formed adjacent to the upper peripheral edge of housing 32 between speaker port opening 34 in the display cover layer for display 14 and the sidewall along the upper edge of housing 32. In some configurations, an opaque masking layer is formed on the underside of the display cover layer in inactive area IA and optical windows 40 are formed from openings within the opaque masking layer. To help optical windows 40 visually blend with the opaque masking layer, a dark ink layer, a metal layer, a thin-film interference filter formed from a stack of dielectric layers, and/or other structures may be overlap windows 40.

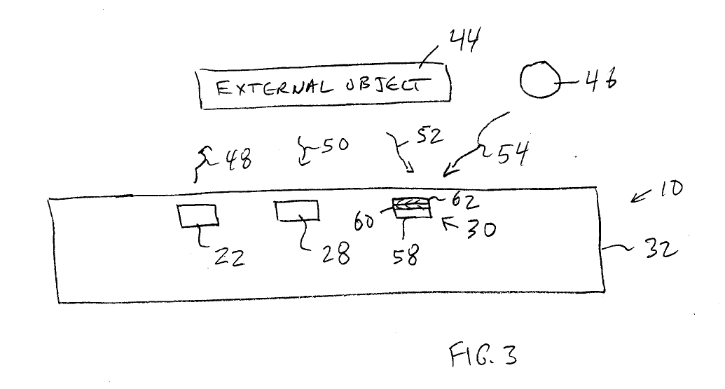

In some modes of operation, device 10 may emit infrared light that has the potential to interfere with ambient light sensor operation. Consider, as an example, a scenario in which control circuitry 16 of device 10 is using infrared image sensor 28 to capture eye scan information and/or facial images (e.g., images of a user's face for use in performing face recognition operations to authenticate the user of device 10). As shown in FIG. 3, to ensure that the eyes and/or face of a user are sufficiently illuminated, device 10 may use infrared light source 22 (e.g., an infrared light-emitting diode, an infrared laser, etc.) to produce infrared light 48. Light 48 may illuminate external objects in the vicinity of device 10 such as external object 44 (e.g., a user's face and/or eyes). Reflected infrared light 50 from external object 44 may be received and imaged using infrared digital image sensor 28 to produce infrared images of the face and/or eyes.

While reflected infrared light 50 is being imaged, stray infrared light reflected from object 44 such as stray infrared light 52 may be present at ambient light sensor 30. To ensure that stray infrared light 52 does not interfere with the ambient light measurements being made with ambient light sensor 30, ambient light sensor 30 may have an infrared blocking filter such as filter 60. Filter 60 may be formed from materials that are transparent to visible light and that block infrared light such as blue glass (e.g., blue borosilicate glass or other infrared-light-blocking glass) and/or from thin-film interference filters formed from stacks of dielectric layers configured to block infrared light (e.g., infrared light at the wavelengths associated with stray light 52 and, if desired, additional infrared wavelengths) while passing visible light. If desired, a light guide may be used in guiding light to ambient light sensor 30. In this type of arrangement, the light guide may incorporate materials that absorb infrared light. For example, a light guide may be formed using infrared-light-blocking materials such as blue glass. Thin-film interference filters may be formed on the entrance and/or exit surfaces of a blue glass light guide to enhance infrared-light-blocking capabilities.

Ambient light 54 may be present in the surroundings of device 10 and may include light emitted from a light source such as light source 46 (e.g., the sun, a lamp, etc.). In some situations, ambient light 54 may be directional (e.g., the rays of light 54 from light source 46 may be aligned in a particular direction due to the nature of light source 46). To ensure that the response of ambient light detector 30 is even over a range of different orientations relative to light source 46 and ambient light 54, a light diffuser such as diffuser 62 may be incorporated into ambient light sensor 30. Ambient light sensor 30 may have one or more photodetectors (e.g., photodiodes) and associated amplifier and digitizing circuitry implemented on light detector integrated circuit 58. Diffuser 62 may overlap visible-light-transmitting-and-infrared-light-blocking filter layer 60 and integrated circuit 58. Diffuser 62 may be formed from polymer, glass, or other suitable materials.

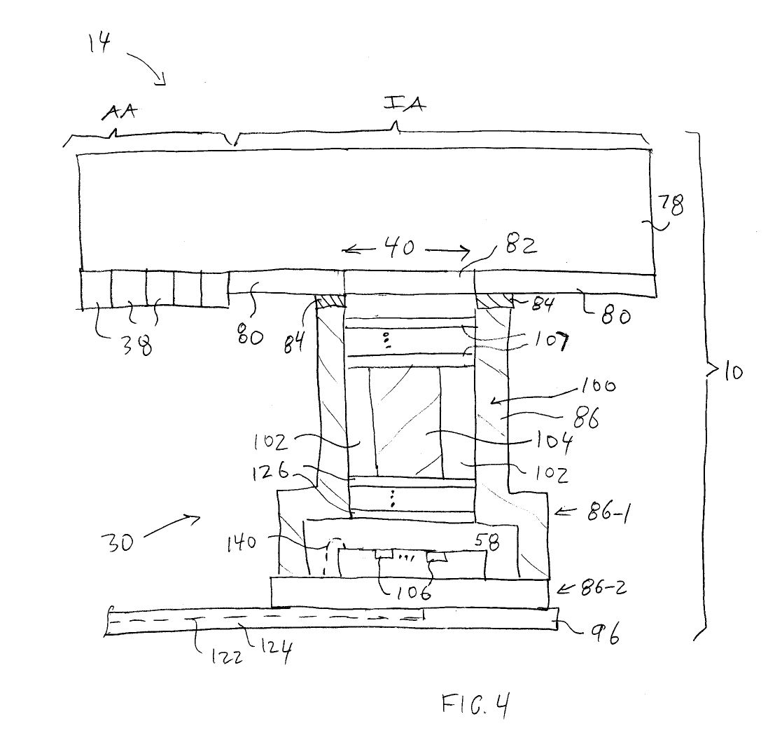

FIG. 4 is a cross-sectional side view of ambient light sensor 30 in an illustrative electronic device 10. Ambient light sensor 30 has a light sensing device such as light detector integrated circuit 58. Light detector integrated circuit 58 may have one or more photodetectors 106 for making ambient light measurements (e.g., intensity measurements and color measurements). If desired, ambient light sensor 30 may be color ambient light sensor and photodetectors 106 may be associated with different color sensitivities (e.g., a red channel, a blue channel, a green channel, etc.).

Light detector integrated circuit 58 of ambient light sensor 30 may be configured to receive light passing through optical component window 40 under display cover layer 78. Display cover layer 78 may be formed from glass, polymer, ceramic, sapphire, and/or other transparent materials.

In active area AA of display 14, display cover layer 78 may overlap pixels 38. In inactive area IA of display 14, display cover layer 78 and optical component window 40 in layer 78 may overlap ambient light sensor 30. Portions of the underside of display cover layer 78 in inactive area IA may be coated with a layer of opaque masking material 80 (e.g., black ink, etc.) to block internal components from view from the exterior of device 10. Window 40 may be formed from an opening in the opaque masking material 80. In window 40, a thin layer of black ink 82 or other material that is at least partially transparent to visible light (e.g., a layer with a light transmission of at least 1%, at least 2%, at least 5%, 1-10%, less than 30%, etc.) may be present to help visually match the appearance of window 40 to the visual appearance of surrounding portions of display cover layer 78 (e.g., to match the appearance of opaque masking material 80) while still allowing ambient light sensor 30 to measure ambient light.

Ambient light sensor 30 may include support structures such as support structure 86 (sometimes referred to as a sensor wall, a sensor body structure, a sensor housing structure, etc.). Clear adhesive such as a layer of pressure sensitive adhesive 84 may be used to couple support structure 86 to the underside of display cover layer 78 in alignment with optical component window 40. Adhesive 84 may be transparent and may overlap optical window 40 and/or adhesive 84 may have a ring shape surrounding the periphery of window 40.

Optional light guide 100 may be used to help guide light from optical window 40 at layer 78 to light detector integrated circuit 58. Light guide 100 may include core 104 and cladding 102. Core 104 and cladding 102 may be formed from transparent materials (e.g., materials that are transparent to visible light) such as glass, polymer, sapphire or other crystalline material, etc. Core 104 may be formed from a material with a higher refractive index than cladding 102 to support light guiding in accordance with the principal of total internal reflection as light passes vertically through light guide 100.

With one illustrative configuration, core 104 (and, if desired, cladding 102) is formed from a material that absorbs infrared light, so that light guide 100 serves as a visible-light-transmitting-and-infrared-light blocking filter (see, e.g., filter 60 of FIG. 3) in addition to serving as a waveguide that guides light. An illustrative infrared blocking material that may be used in forming light guide 100 (e.g., core 104) is blue glass. Polymers and/or other materials may also be used in forming core 104 and/or cladding 102. In some configurations, cladding 102 and/or portions of cladding 102 may, if desired, be formed by a gaseous dielectric such as air. The use of a solid dielectric such as a polymer layer surrounding a core of glass or other higher index material may help prevent dust and other particles from contacting core 104, which could locally defeat total internal reflection.

If desired, optical layers 107 may be interposed between layer 82 and light guide 100 and/or optical layers 126 may be interposed between light guide 100 and light detector integrated circuit 58. Layers 107 and/or layers 126 may include light diffuser layers, light collimating layers, visible-light-transparent-and-infrared-light-blocking filter layers, and/or other optical films. As an example, layers 107 may include one or more light diffusers separated by air gaps or solid materials (e.g., polymers or other materials with different refractive index values than the refractive index values of the diffuser layers) and may include one or more light-collimating layers (e.g., prism films) separated by air gaps or solid materials (e.g., polymers or other materials with different refractive index values than the refractive index values of the prism films). Layers 126 may include one or more visible-light-transmitting-and-infrared-blocking filters.

In some arrangements, some or all of layers 107 may form a dielectric stack of layers of alternating refractive index and/or some or all of layers 126 may form a dielectric stack of layers of alternating refractive index. These stacks, which may be configured to form visible-light-transmitting-and-infrared-light-blocking thin-film interference filters and/or other thin-film interference filters, may be formed as coatings on the upper and/or lower surfaces of light guide 100 respectively and/or may be formed on other substrates in layers 107 and/or layers 126.

As shown in FIG. 4, support structure 86 may form walls that surround layers 107 (e.g., light diffuser layers, etc.), that surround light guide 100, and that surround layers 126 (e.g., visible-light-transmitting-and-infrared-light-blocking filter layer(s)). Viewed from above through layer 78, support structure 86 may extend around the periphery of optical window 40. Support structure 86 may be formed from an opaque material that blocks visible light and that blocks infrared light such as black plastic and/or other opaque materials.

Support structure 86 may be used to form a one-piece or a multi-piece housing for sensor 30. In the example of FIG. 4, support structure 86 has an upper portion 86-1 that houses components such as layers 107, light guide 100, and layers 126 and has a lower portion 86-2 (e.g., a printed circuit, a plastic substrate, etc.). Lower portion 86-2 may support and surround light detector integrated circuit 58. Configurations in which support structure 86 includes three or more sections (e.g., three portions coupled by adhesive, etc.) may also be used.

If desired, lower portion 86-2 may contain vias and other metal traces (e.g., solder pads, signal lines, etc.). Light detector integrated circuit 58 can be mounted to the traces in portion 86-2 using wire bonds such as wire bond 140 or using through-silicon vias and solder joints. Metal traces in portion 86-2 may be used to form signal paths between the contacts to which light detector integrated circuit is coupled and solder pads on the lower surface of portion 86-2. These solder pads may be coupled to mating solder pads on flexible printed circuit 96 using solder joints. Flexible printed circuit 96 may include metal traces 122 (e.g., solder pads, interconnect lines, etc.) supported by dielectric printed circuit material 124 (e.g., polymer or other suitable dielectric).

FIG. 5 is a cross-sectional side view of light guide 100. In the illustrative configuration of FIG. 5, light guide 100 includes a core that is formed from a material that blocks infrared light. Core 104 may, for example, be formed from blue glass. With one illustrative configuration, core 104 is formed from borosilicate glass with copper oxide particles (blue glass portion 140) and optional titanium oxide particles 142 or other particles with an elevated refractive index (e.g., a refractive index of at least 1.7, at least 1.8, at least 1.9, at least 2, at least 2.2, at least 2.5, less than 2.9, etc.) to help increase the refractive index of core 104. Without the addition of the titanium oxide particles, core 104 may have an index of refraction of about 1.5. Titanium oxide has a high refractive index (e.g., about 2.5), so by incorporating titanium oxide particles into core 104 (e.g., by mixing blue glass powder with titanium oxide particles and fusing these materials together), a blue glass of high refractive index (e.g., about 1.7-1.9, 1.75, at least 1.6, at least 1.7, at least 1.8, less than 2.8, etc.) may be achieved. Other high refractive index particles may be mixed with blue borosilicate glass if desired (e.g., other inorganic dielectric particles with a refractive index greater than that of the blue borosilicate glass).

Cladding 102 may surround core 104 and may have a lower refractive index than core 104 to ensure that light that is passing vertically through light guide 100 from optical component window 40 to light detector integrated circuit 58 is confined within light guide 100 in accordance with the principal of total internal reflection. The difference in refractive index between core 104 and cladding 102 may be at least 0.05, at least 0.1, at least 0.15, at least 0.2, at least 0.3, at least 0.4, at least 0.5, less than 2.8, less than 2, or other suitable value. Cladding 104 may, as an example, be formed from a polymer. If desired, core 102 may also be formed from a polymer (e.g., a thiourethane-based polymer with an infrared-light-absorbing additive such as an infrared-light-absorbing dye).

Dielectric stacks 144 of dielectric layers 146 of alternating refractive index may be formed on the upper and/or lower surfaces of light guide 100. Layers 146 may be inorganic layers (e.g., oxides, nitrides, etc.) and may be formed as coatings on the upper and lower surfaces of light guide 100 (e.g., coating layers deposited using physical vapor deposition, chemical vapor deposition, etc.). Dielectric stack 144 on the upper surface of light guide 100 may be included in layers 107 (FIG. 4). Dielectric stack 144 on the lower surface of light guide 100 may be included in layers 126. Stacks 144 may, if desired, be used to form visible-light-transmitting-and-infrared-light-blocking thin-film interference filters.

Light guide 100 may have any suitable aspect ratio (ratio of height H to width W). As an example, the size of light guide 100 along its longitudinal axis (e.g., the dimension along which light passes), which is labeled as height H of FIG. 5, may be 5 mm, 1-10 mm, at least 1mm, at least 2 mm, at least 3 mm, at least 4 mm, at least 5 mm, at least 7 mm, at least 10 mm, less than 20 mm, less than 10 mm, or other suitable value. The lateral dimension(s) of light guide 100 (e.g., width W in one or both dimensions perpendicular to the longitudinal axis of light guide 100) may be 1-10 mm, at least 2 mm, at least 4 mm, at least 6 mm, less than 10 mm, or other suitable value. The aspect ratio of light guide 100 (the ratio of H to the minimum or maximum W) may be at least 1, at least 3, at least 5, at least 7, at least 10, at least 15, at least 25, less than 30, less than 17, less than 14, less than 9, less than 5, less than 3, or other suitable aspect ratio value.

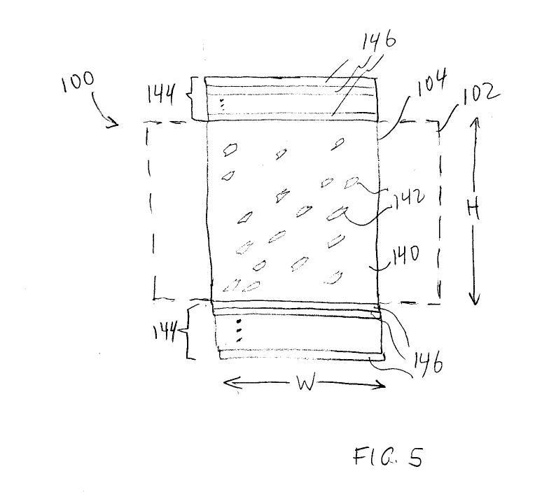

FIG. 6 is a graph showing how thin-film interference filters and the bulk absorption properties of light guide 100 may be used to block infrared light while allowing ambient visible light to be routed to light detector integrated circuit 58. In the graph of FIG. 6, light transmission T for the structures of FIG. 5 have been plotted as a function of wavelength. Curve 150 corresponds to the bulk absorption of light guide 100 (e.g., core 104 and, if desired, cladding 102). Curve 152 corresponds to the light transmission T for a visible-light-blocking-and-infrared-light-blocking thin film interference filter formed from dielectric stacks 144 on the upper (entrance) surface and/or the lower (exit) surface of light guide 100 or from dielectric stacks 144 on other surfaces. As shown in this example, the thin-film interference filter(s) formed form stack(s) 144 may exhibit a steeper transition between the visible light region VIS in which light is transmitted and the infrared light region IR in which light is blocked (as an example). The transition of curves 150 and/or 152 may be at a wavelength of about 620-650 nm, at least 600 nm, less than 700 nm, or other suitable cutoff wavelength). By incorporating both the thin-film interference filter(s) and the bulk absorption of the blue glass of light guide 100, the infrared light blocking capabilities of light guide 100 can be enhanced (e.g., more infrared light will be blocked when both the thin-film interference filter(s) and the blue glass of core 104 are present than when only one of these infrared blocking structures is present).

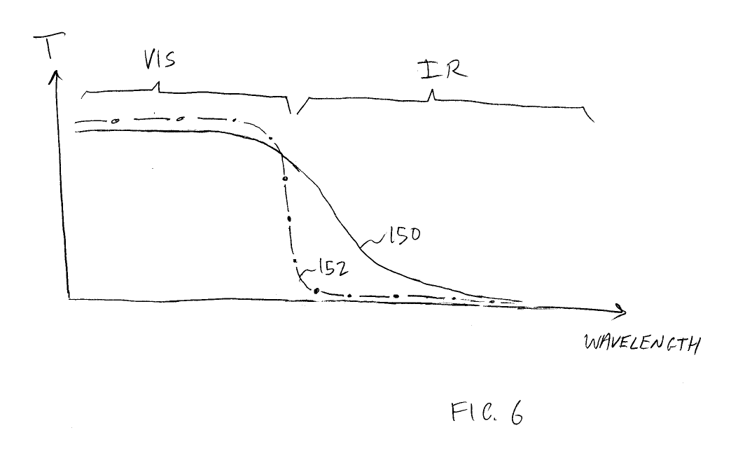

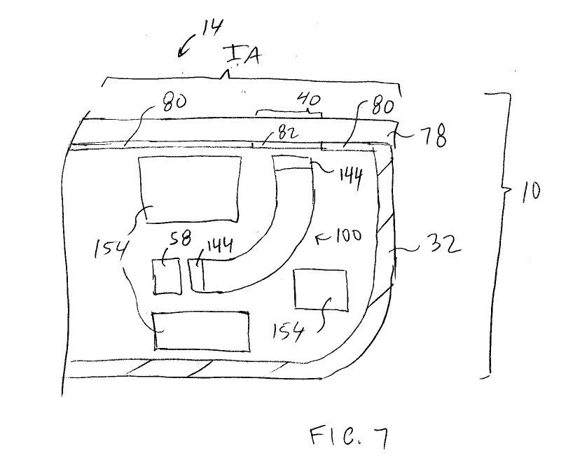

FIG. 7 shows how light guide 100 may have a bend. With or without a bend such as the illustrative bend of FIG. 7, light guide 100 may be used to route ambient light from optical component window 40 past internal components 154 (e.g., a camera, a speaker, an antenna, and/or other components) to light detector integrated circuit 58.

As shown in FIG. 8, light guide 100 may, if desired, be formed from a bundle of optical fibers 156 (e.g., a coherent fiber bundle). The fiber bundle of FIG. 8 may have one or more bends and may be used in routing light 158 to light detector integrated circuit 58 or other optical component. Fibers 156 may have cores surrounded by cladding material. The material of the cores may have a refractive index higher than the cladding material to support total internal reflection. Fibers 156 may have cores of glass or polymer and may have cladding material of glass or polymer (as examples). For example, glass cladding material may be used for fibers 156 that are drawn together to form a fiber bundle.

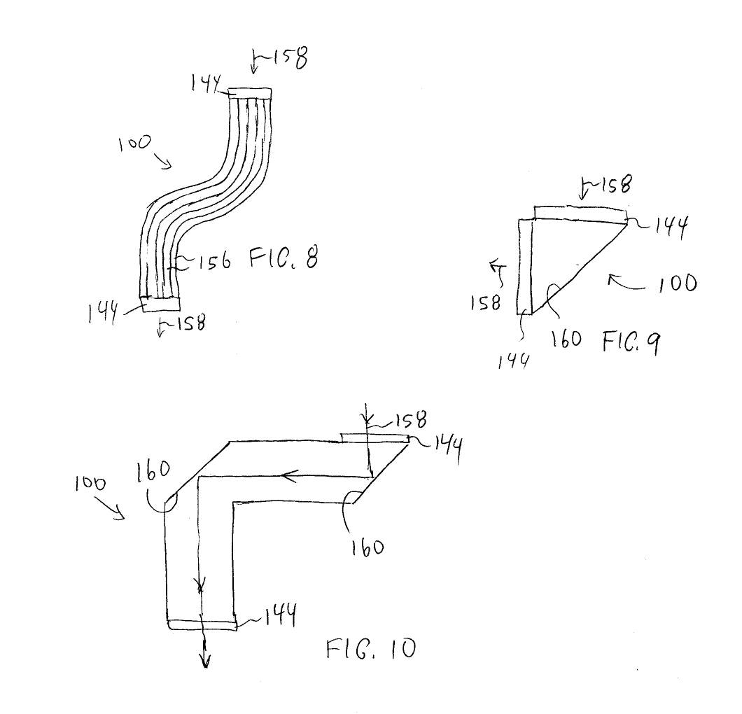

FIGS. 9 and 10 show illustrative configurations for light guide 100 in which light guide 100 has prism surfaces 160 with surfaces 160 that reflect light (e.g., by total internal reflection). In the configuration of FIG. 9, light 158 changes direction by 90° while passing through light guide 100. FIG. 10 shows an illustrative configuration for light guide 100 with two bends formed form reflective prism surfaces 160. Prism surfaces and/or other light guide surfaces can be coated with a dielectric cladding, a dielectric thin-film mirror coating, and/or other materials to help promote light confinement.

Other light guide arrangements may be used, if desired. For example, light guides 100 may have more bends, may have bends formed form gradual curves in light guide 100, may have reflecting surfaces such as surfaces 160, may have thin-film interference filters on prism surfaces, entrance surfaces, and/or exit surfaces, and/or other light guide structures. Light guide 100 may be used in guiding ambient light to light detector integrated circuit 58 and/or may be used in guiding light towards and/or away from other optical components 18 (light emitting devices, image sensors, proximity sensors, optical components operating at visible wavelengths, optical components operating an infrared wavelengths, and/or other optical components 18). The use of light guide 100 to route ambient light to light detector integrated circuit 58 in ambient light sensor 30 is illustrative.

The foregoing is merely illustrative and various modifications can be made to the described embodiments. The foregoing embodiments may be implemented individually or in any combination.

What is claimed is:

1. An electronic device, comprising:
a transparent member having an optical component window;
a light sensor; and
a light guide configured to guide light from the optical component window to the light sensor, wherein the light guide has a core configured to block infrared light and has a cladding surrounding the core.

2. The electronic device defined in claim 1 wherein the core comprises blue glass.

3. The electronic device defined in claim 2 wherein core further comprises particles embedded in the blue glass that have an index of refraction of at least 1.8.

4. The electronic device defined in claim 1 wherein the core comprises borosilicate glass with copper oxide and titanium oxide particles.

5. The electronic device defined in claim 1 wherein the cladding comprises polymer.

6. The electronic device defined in claim 1 further comprising pixels configured to display images, wherein the transparent member comprises a display cover layer having a portion that overlaps the pixels.

7. The electronic device defined in claim 6 wherein the core comprises blue borosilicate glass with embedded titanium oxide particles.

8. The electronic device defined in claim 1 wherein the core has at least one bend.

9. The electronic device defined in claim 1 wherein the core has a longitudinal axis along which the light is guided and wherein the core has a first dimension perpendicular to the longitudinal axis and a second dimension parallel to the longitudinal axis that is at least three times greater than the first dimension.

10. The electronic device defined in claim 9 wherein the second dimension is at least 3 mm.

11. The electronic device defined in claim 1 wherein the light sensor comprises a light detector integrated circuit having a plurality of photodetectors associated respectively with a plurality of ambient light sensor channels of different colors.

12. The electronic device defined in claim 1 further comprising a visible-light-transmitting-and-infrared-light-blocking thin-film interference filter interposed between the optical window and the light sensor.

13. The electronic device defined in claim 12 further comprising a dielectric stack of layers of alternating refractive index on a surface of the light guide, wherein the dielectric stack is configured to form the visible-light-transmitting-and-infrared-light-blocking thin-film interference filter.

14. The electronic device defined in claim 12 wherein the visible-light-transmitting-and-infrared-light-blocking thin-film interference filter includes a first dielectric stack coating on a first surface of the light guide that faces the optical component window and includes a second dielectric stack coating on a second surface of the light guide that faces the light sensor.

15. The electronic device defined in claim 14 wherein the light sensor comprises a light sensor integrated circuit with a plurality of photodetectors sensitive respectively to a plurality of different wavelength ranges.

16. The electronic device defined in claim 15 further comprising a light diffuser between the light guide and the optical component window.

17. An electronic device, comprising:
pixels configured to display images;
a display cover layer that overlaps the pixels;
an infrared light source configured to emit infrared light;
a light guide comprising a core surrounded by a cladding, wherein the core is configured to transmit visible light and block the infrared light; and
an ambient light sensor configured to receive ambient visible light through the light guide.

18. The electronic device defined in claim 17 wherein the core comprises a first material and particles of a second material embedded in the first material, wherein the first material has a first index of refraction, and wherein the second material has a second index of refraction that is greater than the first index of refraction.

19. The electronic device defined in claim 18 wherein the first material comprises borosilicate glass and the second material comprises titanium oxide.

20. An electronic device, comprising:
a glass layer having a portion defining an optical component window through which light passes;
a light guide having a core of infrared-light-blocking glass surrounded by a cladding;
a thin-film interference filter on a surface of the light guide; and
an optical component aligned with the light guide.
